(19) United States
(12) Patent Application Publication
(10) Pub. No.: US 2017/0103612 A1
(43) Pub. Date: Apr. 13, 2017

(54) Card-Based Metagame

(71) Applicant: Mediarex Enterprises Ltd., Tortola (VG)

(72) Inventor: Alexandre Dreyfus, Sliema (MT)

(21) Appl. No.: 14/878,786

(22) Filed: Oct. 8, 2015

(51) Int. Cl. G07F 17/32; A63F 13/69; A63F 1/00

(52) U.S. Cl. CPC G07F 17/3262; A63F 1/00; A63F 13/69; G07F 17/3293; A63F 2001/005

(57) ABSTRACT

A card-based metagame includes a first deck of cards used to play a game according to a set of rules. The card-based metagame also includes a second deck of cards used to change the play of the game. The first deck may be the standard playing card deck or the 52-card deck of French playing cards. The cards of the second deck may be different than the cards of the first deck. In some implementations, the first and/or second decks of cards are physical cards. In other implementations, the first and/or second decks of cards are digital representations of cards provided by a computing device.

### FIELD

The described embodiments relate generally to card games. More particularly, the present embodiments relate to modifying a game played with a first deck of cards according to a set of rules using a second deck of cards.

### BACKGROUND

People play a variety of different games. Card-based games are games that use one or more types of cards as part of play. For example, many card-based games use the 52-card deck of French playing cards (sometimes including one or more additional, sometimes optional, cards such as one or more Jokers). This deck is often referred to as the standard playing card deck.

One well known family of card-based games that uses the 52-card deck of French playing cards is poker. The poker family of card-based games generally involves individual play, and sometimes betting, where the winner is determined by the ranks and combination of players' cards. Some or all of a player's cards may be hidden from other players until the end of a hand. Card-based games in the poker family typically vary in the number of cards dealt, the inclusion and/or number of shared or “community” cards, the number of cards that remain hidden, and/or betting procedures if betting is involved.

For example, five card straight poker involves dealing a complete hand of five cards to each player where the winner is determined by the ranks and combination of players' cards. By way of contrast, five card draw poker involves dealing a complete hand of five cards to each player, face-down, and players (after betting in some cases) are allowed to attempt to change their hand by discarding unwanted cards in order to be dealt new ones.

By way of another example, Texas hold 'em is a community card poker game where two cards (hole cards) are dealt to each player and then five community cards are placed face up by the dealer (a series of three called “the flop” and then an additional single card called “the turn” or “fourth street” followed by an additional single card called “the river” or “fifth street). The winner is determined by the best five card poker hand that can be made using cards from either the community or a player's hole cards. When betting is used, players may have the option to check, bet, raise, or fold after each deal (e.g., prior to the flop, on the flop, on the turn, and on the river).

Texas hold 'em provides more variety of play and more opportunity for strategy based play as compared to five card straight poker or five card draw poker. However, variety of play and opportunity for strategy based play may still be limited by the 52-card deck of French playing cards and the Texas hold 'em set of rules.

### SUMMARY

The present disclosure relates to methods and systems for card-based metagames (e.g., a card-based game including, encompassing, and/or centered on another card-based game). A card-based metagame includes a first deck of cards used to play a game according to a set of rules. The card-based metagame also includes a second deck of cards used to change the play of the game. Through use of the second deck of cards, a greater variety of play and/or greater opportunity for strategy based play may be provided for the game. Thus, card-based metagame expands the play of the game. In some implementations, the first and/or second decks of cards are physical cards. In other implementations, the first and/or second decks of cards are digital representations of cards provided by a computing device.

In various embodiments, a computer system includes a processing unit, a communication component communicably coupled to the processing unit, and a non-transitory storage medium communicably coupled to the processing unit. The storage medium stores first representations of a first deck of cards, second representations of a second deck of cards, a set of rules, and instructions. The processing unit executes the instructions stored in the non-transitory storage medium to provide at least one of the first representations of the first deck of cards, provide at least one of the second representations of the second deck of cards, allow play of a game according to the set of rules using the at least one of the first representations of the first deck of cards, and allow use of the at least one of the second representations of the second deck of cards to change the play of the game.

In some implementations, cards of the second deck of cards are not included in the first deck of cards. In various implementations, the second deck of cards is a number of second decks that corresponds to a number of players of the game.

In numerous implementations, the game is Texas hold 'em. In various examples, the at least one of the second representations of the second deck of cards is at least one of a hole modification card, a board modification card, a community turn modification card, a community flop modification card, a community river modification card, a value increment card, a value decrement card, a suit change card, a re-deal card, a card switch card, a card combination creation card, a bet modification card, an extra card obtaining card, an order of play alteration card, or a view other player hole card.

In some embodiments, a card-based metagame includes a first deck of cards, a second deck of cards, and a set of rules. The first deck of cards is used to play of a game according to the set of rules. The second deck of cards is used to change the play of the game. In numerous implementations, the first deck of cards is a first digital graphic representation and the second deck of cards is a second digital graphic representation.

In various implementations, the card-based metagame further includes an additional set of rules. The second deck of cards is used according to the additional set of rules to change the play of the game. In some examples, the additional set of rules specifies a time when cards of the second deck of cards may be used. In various examples, at least one of the second deck of cards includes a use limitation.

In some implementations, the first deck of cards is a 52-card deck of French playing cards. In various implementations, the game is a poker game.

In numerous embodiments, a method of enabling play of a card-based metagame includes providing at least one of a first deck of cards, allowing play of a game according to a set of rules using the at least one of the first deck of cards, providing at least one of a second deck of cards, and allowing use of the at least one of the second deck of cards to change the play of the game.

In some embodiments, the method may further include accepting at least one bet on the game. In various embodiments, the method may further include providing at least one additional card of the first deck of cards in response to use of the at least one of the second deck of cards.

In numerous embodiments, the operation of providing the at least one of the first deck of cards includes transmitting data regarding the at least one of the first deck of cards to a browser of a client computer. In various embodiments, the operation of providing the at least one of the second deck of cards further includes providing the at least one of the second deck of cards to a first player and concealing the at least one of the second deck of cards from a second player until the at least one of the second deck of cards is used.

In some embodiments, the first deck of cards and the second deck of cards have at least one card in common. In such embodiments, the at least one card may have a different function with respect to the first deck of cards than with respect to the second deck of cards.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a card-based metagame system.

FIG. 2A depicts play of a Texas hold 'em card-based game hand after the common flop has been dealt.

FIG. 2B depicts the play of the Texas hold 'em card-based game hand of FIG. 2A after the community turn card has been dealt.

FIG. 2C depicts the play of the Texas hold 'em card-based game hand of FIG. 2B after the community river card has been dealt.

FIG. 3A depicts play of a Texas hold 'em card-based metagame hand after the common flop has been dealt.

FIG. 3B depicts the play of the Texas hold 'em card-based game hand of FIG. 3A upon use of one of the second player's modifier cards.

FIG. 3C depicts the play of the Texas hold 'em card-based game hand of FIG. 3B upon use of one of the first player's modifier cards.

FIG. 3D depicts the play of the Texas hold 'em card-based game hand of FIG. 3C after the community turn card has been dealt.

FIG. 3E depicts the play of the Texas hold 'em card-based game hand of FIG. 3D after the community river card has been dealt.

FIG. 3F depicts the play of the Texas hold 'em card-based game hand of FIG. 3E upon use of another of the first player's modifier cards.

FIG. 3G depicts the play of the Texas hold 'em card-based game hand of FIG. 3F upon use of another of the second player's modifier cards.

FIG. 4 depicts a computer system for enabling play of and/or playing a card-based metagame.

FIG. 5 depicts a flow chart illustrating a method for enabling play of a card-based metagame. The card-based metagame may be the card-based metagame depicted in FIGS. 1 and/or 3A-3G. The method may be performed by the system of FIG. 4.

FIG. 6 depicts a flow chart illustrating a method for playing a card-based metagame. The card-based metagame may be the card-based metagame depicted in FIGS. 1 and/or 3A-3G. The method may be performed by the system of FIG. 4.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and computer program products that embody various elements of the present disclosure. However, it should be understood that the described disclosure may be practiced in a variety of forms in addition to those described herein.

The following disclosure relates to methods and systems for card-based metagames (e.g., a card-based game including, encompassing, and/or centered on another card-based game). A card-based metagame may include a set of rules and a first deck of cards that are used to play a game according to the set of rules. The card-based metagame may also include a second deck of cards that may be used to change the play of the game. Through use of the second deck of cards, a greater variety of play may be provided for the game than would be possible without the second deck of cards. In some cases, use of the second deck of cards may also provide a greater opportunity for strategy based play than would be possible without the second deck of cards. Thus, card-based metagame may expand the play of the game.

In some implementations, the first and/or second deck of cards may be physical cards. In other implementations, the first and/or second deck of cards may be digital representations of cards, such as one or more digital graphic representations, images, text, and so on. In various implementations, the card-based metagame may be provided by one or more computing devices that execute one or more software instructions and/or by one or more server computing devices that interact with one (such as transmitting data regarding one or more cards to, receiving input from, and so on) or more applications such as an Internet browser executing on one or more client computing devices. Various embodiments are possible and contemplated without departing from the scope of the present disclosure.

In various implementations, the cards of the second deck may not be included in the first deck. However, in other implementations, the first and second decks may include the same cards but the cards may have different functions with respect to the first deck than with respect to the second deck. In some implementations, one or more of the first and second decks may be shared between players of the game. However, in other implementations, one or more of the first and second decks may be a number of decks that corresponds to the number of players of the game. In such an implementation, each of the first and/or second decks may be associated with a particular player.

In some implementations, the first deck of cards may be deck of cards commonly referred to as the standard playing card deck or the 52-card deck of French playing cards. In various implementations, the game may be a poker game (such as straight poker; draw poker; stud poker; pai gow poker; a community card poker game such as Texas hold 'em, Omaha hold 'em, Pineapple, Manilla, and so on; and so on). In other implementations, the game may be other kinds of card-based games such as blackjack, baccarat, faro, gin rummy, progressive rummy, spades, crazy eights, hearts, whist, a trading card game, a customizable card game, and so on. The game may or may not include betting in one or more implementations. In some implementations, one or more of the first and/or second deck of cards provided to a player may be concealed from other players until used, the end of a hand, the end of a game, revealed by the player, and so on.

In various implementations, the card-based metagame may include an additional set of rules and the second deck of cards may be used according to the additional set of rules to change the play of the game. For example, the additional set of rules may specify when the cards of the second deck may be used. In some implementations, one or more of the additional set of rules may be included on cards of the second deck of cards. For example, one of the second deck of cards may include a use limitation.

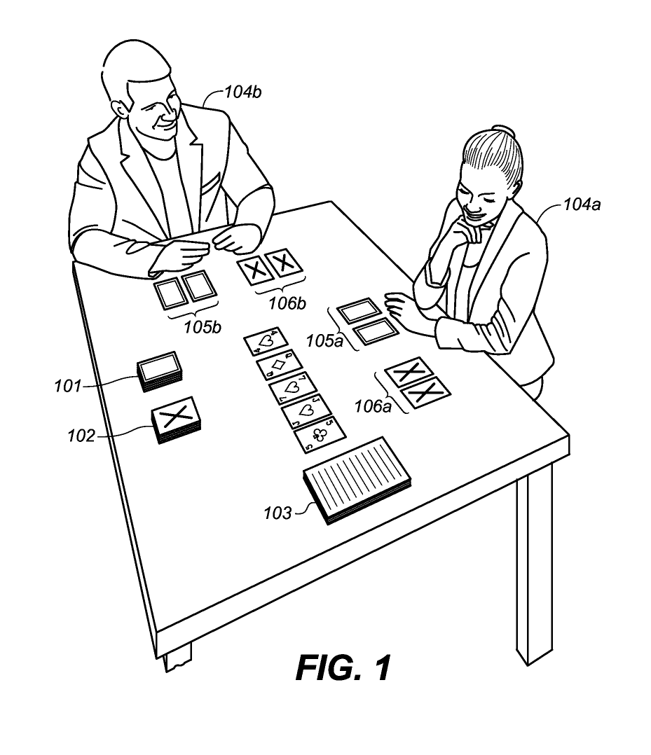

These and other embodiments are discussed below with reference to FIGS. 1-6. However, those skilled in the art will readily appreciate that the detailed description given herein with respect to these Figures is for explanatory purposes only and should not be construed as limiting.

FIG. 1 depicts a card-based metagame system 100. A number of players 104a, 104b are playing a card-based metagame. The players 104a, 104b are using cards 105a, 105b from a first deck of cards 101 to play a game according to a set of rules 103 and are using cards 106a, 106b from a second deck of cards 102 to change play of the game.

FIG. 1 illustrates play of a particular card-based game and metagame. For example, a number of cards are revealed and a number of cards are concealed. Further, the revealed cards are shown as the standard playing card deck or the 52-card deck of French playing cards. However, it is understood that this is an example for the purposes of illustration and do not limit the card-based metagame system 100.

Various cards from the second deck of cards 102 may be used to change play of the game in a variety of different ways. For example, cards from the second deck of cards 102 may change one or more values (such as numerical value, suit, and so on) of cards from the first deck of cards 101, change the order of play, skip a player's turn, steal a turn for a player, switch various cards, cause a re-deal of one or more cards, and/or any other action that may influence and/or affect the game.

By way of example, the game may be Texas hold 'em or similar card-based game in some implementations. In such implementations, cards from the second deck of cards 102 may be a hole modification card, a board (e.g., including the flop cards, the community turn card, and/or the community river card) modification card, a community turn modification card, a community flop modification card, a community river modification card, a value increment card, a value decrement card, a suit change card, a re-deal card, a card switch card, a card combination creation (or destruction) card, a bet modification card, an extra card obtaining card, an order of play alteration card, or a view other player hole card.

By way of a first illustration, a value increment card may change a Queen card to a King whereas a value decrement card may change a ten to a nine. Such value increment/decrement cards may be playable on certain cards, such as cards in the player's hole, the opponent's hole, the board, the community flop, the community turn, the community river, and so on.

By way of a second illustration, an extra card obtaining card may allow drawing of an extra hole or community card. In such a case, a hand may be formed from five of the eight now available hole and community cards. Where the extra card is a hole card, the player playing the extra card obtaining card may be able to utilize the extra hole card. Where the extra card is a community card, multiple players may be able to utilize the extra community card.

By way of a third illustration, a suit change card may change a suit to any other suit, switch clubs to spades, switch clubs to spades and spades to clubs, switch diamonds to hearts, switch diamonds to hearts and hearts to diamonds, and/or any other combination. Such suit change cards may be playable on certain cards, such as cards in the player's hole, the opponent's hole, the board, the community flop, the community turn, the community river, and so on.

By way of a fourth illustration, in some examples, a card switch card may swap one of a player's hole card for a random card from the burn piles of the community flop, turn, or river. In other examples, a card switch card may swap one or more one of a player's hole card for another player's hole card.

By way of a fifth illustration, in various examples, a re-deal card may re-deal one or more of a player's hole cards and/or one or more other player's hole cards. In various other examples, a re-deal card may re-deal the community flop, the community turn, the community river, and so on.

By way of a sixth illustration, a card combination creation card may make a pair out of a player's hole cards. The pair may take the value of the higher of the player's two hole cards and/or the lower of the player's two hole cards. The pair may take the suit of the higher of the player's two hole cards, the lower of the player's two hole cards, be specified by the player who played the card combination creation card, be specified by the card combination creation card, and so on.

By way of a seventh illustration, a card combination creation card may make a pair, three of a kind, or four of a kind out of the community cards (e.g., the community flop, the community turn, and/or the community river). The combination may take the value of the higher of the cards affected, the middle of the cards affected, the lower of the cards affected, and so on. The combination may take the suit of the higher of the cards affected, the middle of the cards affected, the lower of the cards affected, be specified by the user who played the card combination creation card, be specified by the card combination creation card, and so on.

By way of an eighth illustration, a card combination destruction card may make break up a pair of another player's hole cards. One or more cards of the former pair may take a random value, an incremented value, a decremented value, a value specified by the player of the card combination destruction card, be specified by the card combination destruction card, and so on.

By way of a ninth illustration, in some examples, a bet modification card may remove another player's last bet and/or one or more other previous bets. In other examples, a bet modification card may stop all further betting for a particular hand and/or otherwise affect betting.

Texas hold 'em games typically involve multiple hands. In some implementations, players may receive one or more cards (such as two, seven, and so on) from the second deck of cards 102 (and/or a second deck of cards 102 specifically dedicated to that player) each hand and use them within that hand. In other implementations, one or more cards (such as two, seven, and so on) from the second deck of cards 102 (and/or a second deck of cards 102 specifically dedicated to that player) may be dealt to the player at the start of the game rather than for a specific hand and may be used during any hand during the game.

In various implementations, players may have the opportunity to ban one or more cards from the second deck of cards 102 (and/or a second deck of cards 102 specifically dedicated to one or more other players). The banning may take place before cards from the second deck of cards 102 are dealt and may include the player selecting one or more of the cards from the second deck of cards 102 to remove that then cannot be dealt to other players and/or otherwise used in a hand or the game. In some implementations, the player banning the cards from the second deck of cards 102 may be allowed to view the cards from the second deck of cards 102 during banning. In other implementations, the player may ban the cards from the second deck of cards 102 randomly without first being able to view.

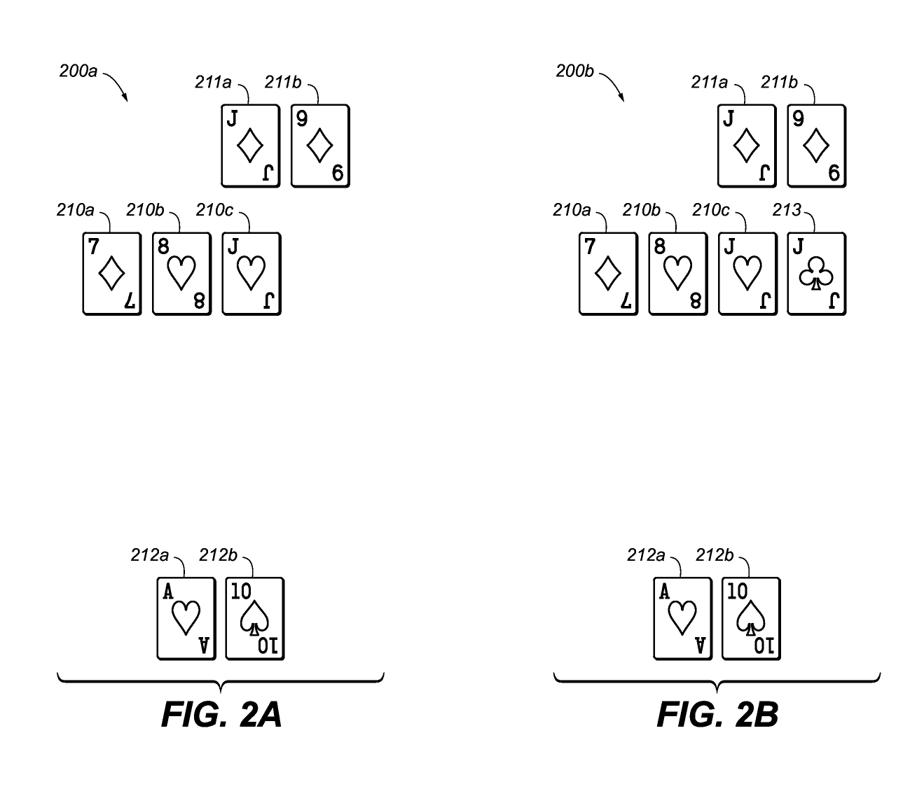

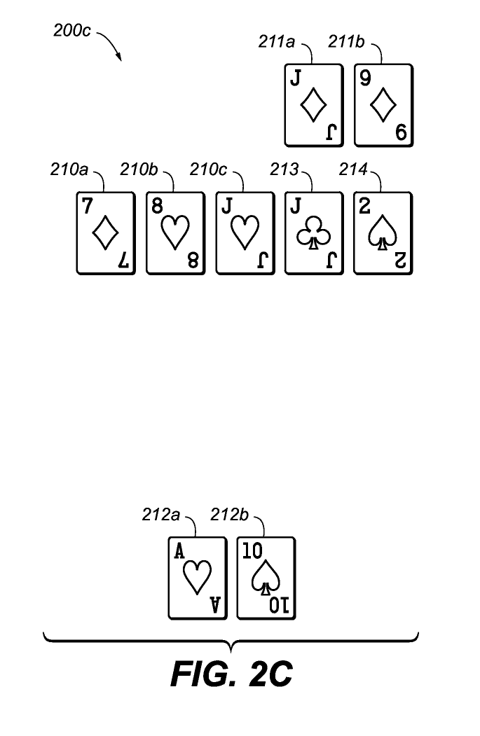

FIG. 2A depicts play 200a of a Texas hold 'em card-based game hand after the common flop has been dealt from a first deck. The common flop includes cards 210a (shown as a seven of diamonds), 210b (shown as an eight of hearts), and 210c (shown as a Jack of hearts). A first player has hole cards 211a (shown as a Jack of diamonds), 211b (shown as a 9 nine of diamonds) from the first deck and a second player has hole cards 212a (shown as an Ace of hearts), 212b (shown as a ten of spades) from the first deck. Though hole cards are normally concealed until the end of a hand, the first and second players' hole cards 211a, 211b, 212a, 212b are illustrated face-up for the purposes of clarity.

FIG. 2B depicts the play 200b of the Texas hold 'em card-based game hand of FIG. 2A after the community turn card 213 has been dealt from the first deck. As shown, the community turn card 213 is a Jack of clubs. FIG. 2C depicts the play 200c of the Texas hold 'em card-based game hand of FIG. 2B after the community river card 214 has been dealt from the first deck. As shown, the community river card 214 is a two of spades.

The highest ranking hand that the first player can assemble out of the first player's hole cards 211a, 211b; the community flop cards 210a, 210b, 210c; the community turn card 213; and the community river card 214 is three Jacks (using the hole card 211a, the community flop card 210c, and the community turn card 213). By way of contrast, the highest ranking hand that the second player can assemble out of the second player's hole cards 212a, 212b; the community flop cards 210a, 210b, 210c; the community turn card 213; and the community river card 214 is two Jacks (using the community flop card 210c and the community turn card 213). Three of a kind beats two of a kind, so the first player wins the hand.

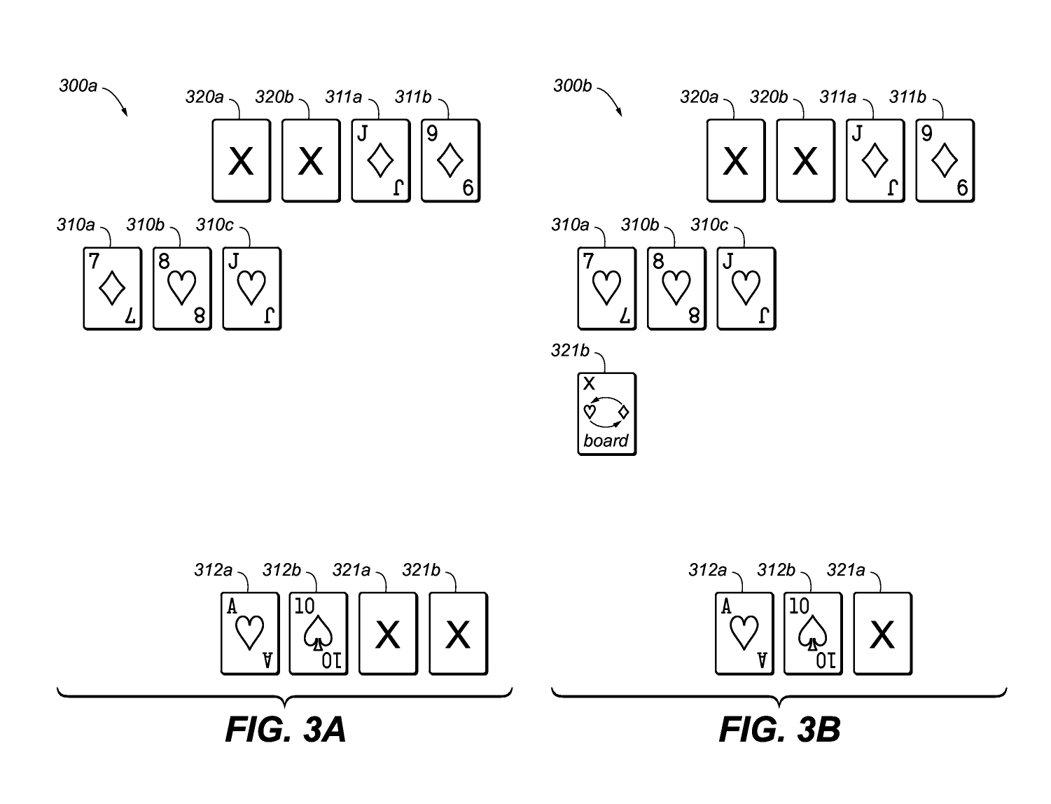

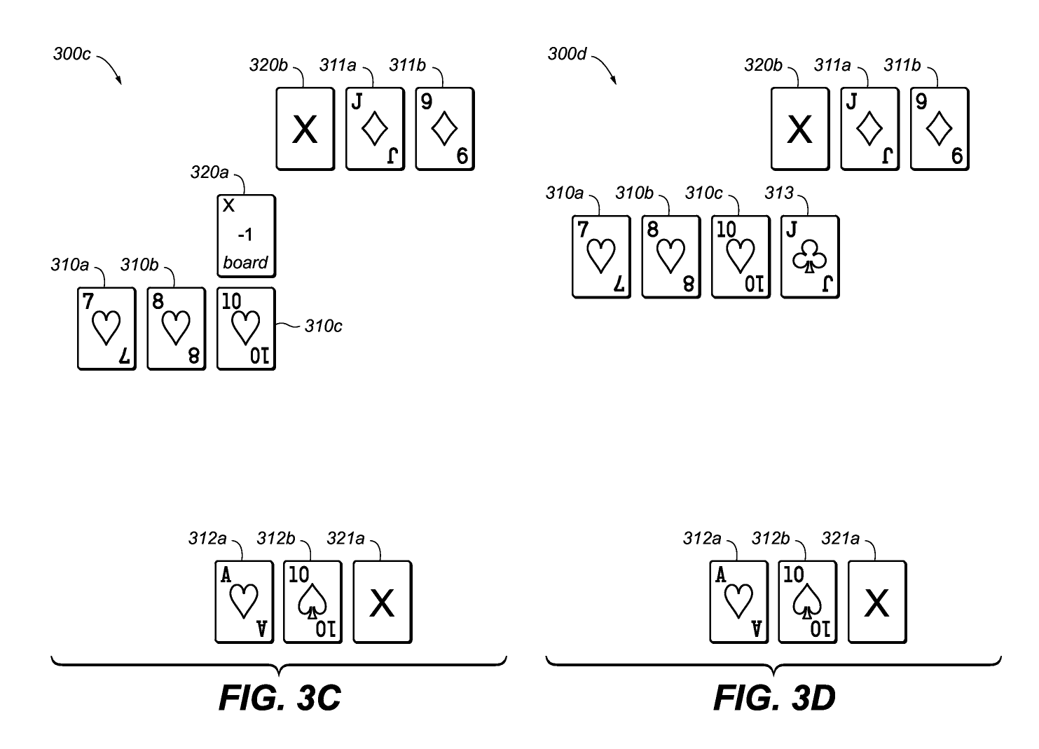

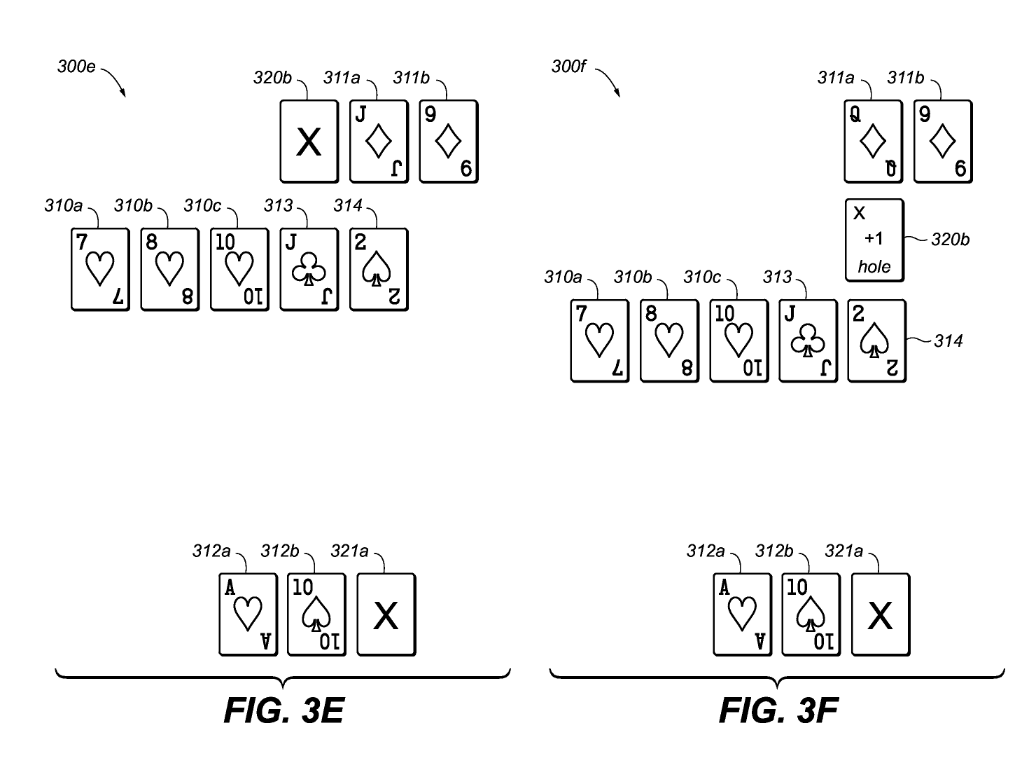

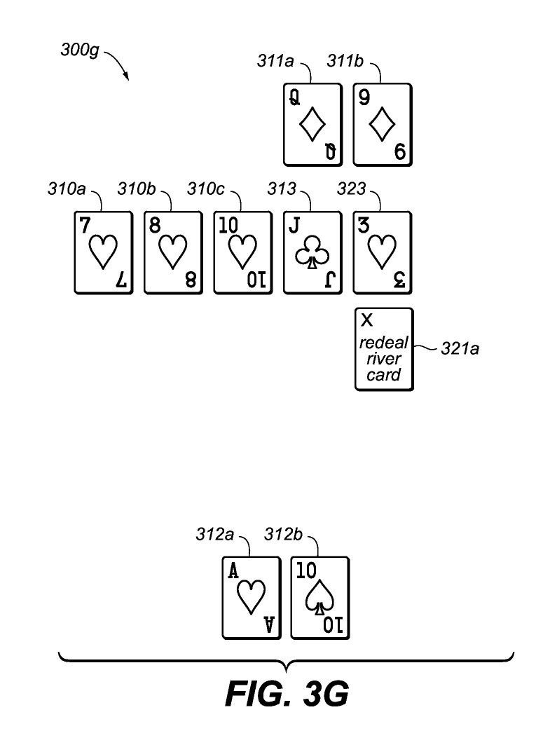

By way of contrast, FIG. 3A depicts play 300a of a Texas hold 'em card-based metagame (which may be the card-based metagame system 100 of FIG. 1) hand after the common flop has been dealt. Contrasted with FIGS. 2A-2C, the first player also has modifier cards 320a, 320b (shown concealed face-down) from a second deck and the second player also has modifier cards 321a, 321b (shown concealed face-down) from a second deck. In order to illustrate the contrast between the Texas hold 'em card-based game and the Texas hold 'em card-based metagame and how the card-based metagame alters play, the initial cards 310a, 310b, 310c, 311a, 311b, 312a, 312b, 313, and 314 of FIGS. 3A-3G from a first deck are the same as the cards 210a, 210b, 210c, 211a, 211b, 212a, 212b, 213, and 214.

FIG. 3B depicts the play 300b of the Texas hold 'em card-based game hand of FIG. 3A upon use of one of the second player's modifier cards 321b. Now shown face-up or revealed, the second player's modifier card 321b is a suit change card that may be used to change diamonds to hearts and hearts to diamonds and includes a use limitation that the suit change may be used on any board card. As shown, the second player's modifier card 321b is used to change the community flop card 310a from a seven of diamonds to a seven of hearts.

FIG. 3C depicts the play 300c of the Texas hold 'em card-based game hand of FIG. 3B upon use of one of the first player's modifier cards 320a. Now shown face-up or revealed, the first player's modifier card 320a is a value decrement card (with a value of −1) and includes a use limitation that the suit change may be used on any board card. As shown, the first player's modifier card 320a is used to change the community flop card 310c from a Jack of hearts to a ten of hearts.

FIG. 3D depicts the play 300d of the Texas hold 'em card-based game hand of FIG. 3C after the community turn card 313 has been dealt. FIG. 3E depicts the play 300e of the Texas hold 'em card-based game hand of FIG. 3D after the community river card 314 has been dealt.

FIG. 3F depicts the play 300f of the Texas hold 'em card-based game hand of FIG. 3E upon use of another of the first player's modifier cards 320b. Now shown face-up or revealed, the first player's modifier card 320b is a value increment card (with a value of +1) and includes a use limitation that the increment may be used on the first player's hole cards 311a, 311b. As shown, the first player's modifier card 320b is used to change the first player's hole card 311a from a Jack of diamonds to a Queen of diamonds.

FIG. 3G depicts the play 300g of the Texas hold 'em card-based game hand of FIG. 3F upon use of another of the second player's modifier cards 321a. Now shown face-up or revealed, the second player's modifier card 321a is a re-deal card and includes a use limitation that the re-deal may be used on the community river card 314. As shown, the second player's modifier card 321a is used to re-deal the community river card 314, resulting in discard of the two of spades community river card 314 and dealing of a three of hearts community river card 323.

The highest ranking hand that the first player can assemble out of the first player's hole cards 311a, 311b; the community flop cards 310a, 310b, 310c; the community turn card 313; and the community river card 323 is a straight (using the hole card 311a, the community turn card 313, the community flop card 310c, the hole card 311b, and the community flop cards 310a, 310b). By way of contrast, the highest ranking hand that the second player can assemble out of the second player's hole cards 312a, 312b; the community flop cards 310a, 310b, 310c; the community turn card 313; and the community river card 314 is a flush (using the hole card 312a, the community flop cards 310a, 310b, 310c, and the community river card 323). A flush beats a straight, so the second player wins. This demonstrates how a card-based metagame can alter play of a card-based game as the Texas hold 'em card-based game hand of FIGS. 2A-2C and the Texas hold 'em card-based metagame hand of FIGS. 3A-3G resulted opposite outcomes despite having the same initial cards 310a, 310b, 310c, 311a, 311b, 312a, 312b, 313, and 314.

FIGS. 2A-3G are illustrated and discussed above in the context of a Texas hold 'em game. However, it is understood that these are examples. In various implementations, the game may be a poker game other than Texas hold 'em (such as straight poker; draw poker; stud poker; pai gow poker; a community card poker game such as Omaha hold 'em, Pineapple, Manilla, and so on; and so on) and/or other kinds of card-based games such as blackjack, baccarat, faro, gin rummy, progressive rummy, spades, crazy eights, hearts, whist, a trading card game, a customizable card game, and so on.

Returning to FIG. 1, the cards of the second deck 102 may not be included in the first deck 101. However, this is an example. In other implementations, the first and second decks 101, 102 may include the same cards but the cards may have different functions with respect to the first deck 101 than with respect to the second deck 102.

The first and second decks 101, 102 are shared between players 104a, 104b of the game in FIG. 1. However, in other implementations, one or more of the first and second decks 101, 102 may be a number of decks 101, 102 that corresponds to the number of players 104a, 104b of the game. In such an implementation, each of the first and/or second decks 101, 102 may be associated with a particular player 104a, 104b.

The card-based metagame system 100 of FIG. 1 is illustrated and described above as including the set of rules 103 for using the cards 105a, 105b from the first deck of cards 101 to play the game. However, it is understood that this is an example. In various implementations, the card-based metagame system 100 may include an additional set of rules and the second deck of cards 102 may be used according to the additional set of rules to change the play of the game. For example, the additional set of rules may specify when the cards of the second deck 102 may be used (such as when cards are dealt; when players 104a, 104b check, bet, call, and so on; at the start or end of turns; and so on). One or more of such an additional set of rules may be included on cards of the second deck of cards 102. For example, cards of the second deck of cards 102 may include a use limitation specifying limits on how the card may be used.

Although the card-based metagame system 100 of FIG. 1 is not illustrated and described above as including betting, it is understood that this is an example for the sake of clarity. In various implementations, the game may or may not include betting.

The card-based metagame system 100 of FIG. 1 is illustrated and described above (as well as FIGS. 3A-3G, though FIGS. 3A-3G may also illustrate a visual display as opposed to physical cards) such that the first and second deck of cards 101, 102 are physical cards. However, it is understood that this is an example. In various implementations, the first and/or second deck of cards 101, 102 may be digital representations of cards, such as one or more digital graphic representations, images, text, and so on. In various implementations, the card-based metagame may be provided by one or more computing devices that execute one or more software instructions and/or by one or more server computing devices that interact with one (such as transmitting data regarding one or more cards to, receiving input from, and so on) or more applications such as an Internet browser executing on one or more client computing devices.

Although FIGS. 3A-3G are illustrated and described as including two modifier cards 320a, 320b, 321a, 321b for each player, it is understood that this is an example. In various implementations, any number of modifier cards 320a, 320b, 321a, 321b may be used, such as seven. In various implementations, players may have different numbers of modifier cards 320a, 320b, 321a, 321b.

Further, although the modifier cards 320a, 320b, 321a, 321b are illustrated and described in the context of FIGS. 3A-3G as for the illustrated hand, it is understood that this is an example. Texas hold 'em and various other card-based games may include multiple hands in a game and modifier cards 320a, 320b, 321a, 321b may be dealt and used throughout an entire game rather than on a per hand basis without departing from the scope of the present disclosure.

Additionally, in various implementations, players may have the opportunity to ban one or more modifier cards 320a, 320b, 321a, 321b. A player may have remove one or more modifier cards 320a, 320b, 321a, 321b from a deck before another player is allowed to select a number of modifier cards 320a, 320b, 321a, 321b for play. The player removing the modifier cards 320a, 320b, 321a, 321b from the deck may or may not be allowed to see the modifier cards 320a, 320b, 321a, 321b being removed when removing.

For example, in some implementations, a deck of modifier cards 320a, 320b, 321a, 321b may be included for each player. Prior to play of a hand, the first player may ban one or more modifier cards 320a, 320b, 321a, 321b from the second player's deck of modifier cards 320a, 320b, 321a, 321b. The second player may then select a number of modifier cards 320a, 320b, 321a, 321b from the second player's deck of modifier cards 320a, 320b, 321a, 321b for use with in the hand or throughout all hands of the game until those particular selected modifier cards 320a, 320b, 321a, 321b are used. The second player may also have the opportunity to ban one or more modifier cards 320a, 320b, 321a, 321b from the first player's deck of modifier cards 320a, 320b, 321a, 321b before the first player is allowed to select.

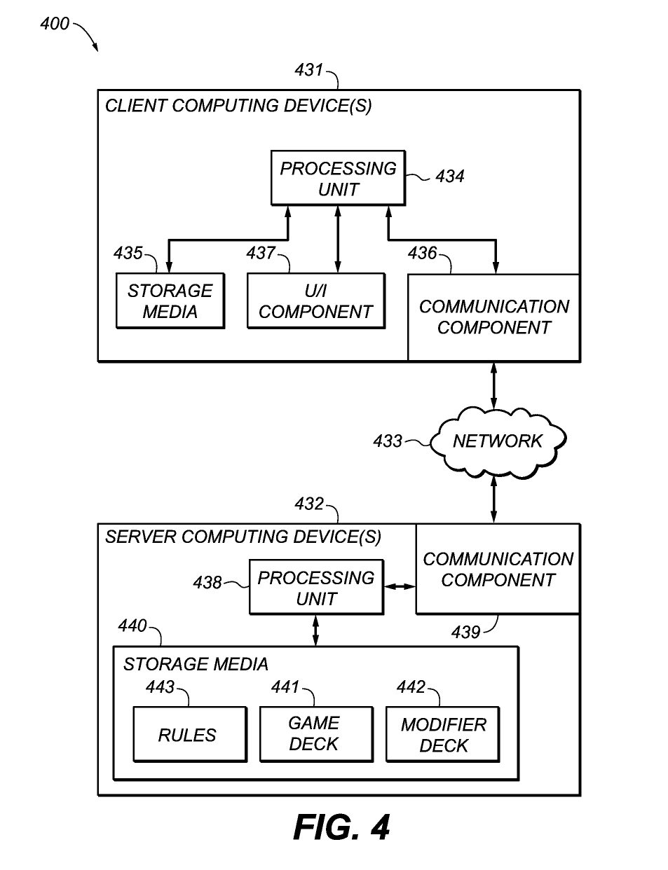

For example, FIG. 4 depicts block diagram illustrating a computer system 400 for enabling play of and/or playing a card-based metagame. The computer system 400 may include one or more client computing device(s) 431 that communicate with one or more server computing device(s) 432 via one or more wired and/or wireless networks 433.

The server computing device 432 may include one or more processing units 438, one or more communication components 439, one or more non-transitory storage media 440 (which may take the form of, but is not limited to, a magnetic storage medium; optical storage medium; magneto-optical storage medium; read only memory; random access memory; erasable programmable memory; flash memory; and so on), and/or other components. Similarly, the client computing device 431 may include one or more processing units 434, storage media 435, communication components 436, user interface components (such as one or more displays, speakers, printers, microphones, keyboards, touch screens, computer mice, track pads, touch sensors, force sensors, and so on), and/or other components.

The storage medium 440 of the server computing device 432 may store a game deck 441 (or a first deck of cards), a modifier deck 442 (or a second deck of cards), and one or more sets of rules such as a set of rules 443 for using the game deck 441 to play a game. The storage medium 440 may also store one or more sets of instructions executable by the processing unit 438 to perform a method of enabling play of a card-based metagame.

For example, the processing unit 438 may execute the instructions to provide one or more representations of cards of the game deck 441, provide one or more representations of cards of the modifier deck 442, allow play of the game according to the set of rules 443 using the provided representations of the cards of the game deck 441, and allow use of the provided representations of the cards of the modifier deck 442 to change the play of the game. The instructions executed by the processing unit 438 may perform one or more of these operations by exchanging data with the client computing device 431 via the communication components 439 and 436.

For example, the processing unit 434 of the client computing device 431 may execute instructions stored in the storage medium 435 to implement an application such as an Internet browser. The Internet browser executing on the client computing device 431 may provide output via the user interface component 437 relating to data associated with the card-based metagame received from the server computing device 432 and/or transmit input associated with the card-based metagame received from a user via the user interface component 437.

In such an example, the server computing device 432 may allow play of the game according to the set of rules 443 using the provided representations of the cards of the game deck 441 based on what data the server computing device 432 transmits to the client computing device 431 and/or what input the server computing device 432 accepts from the client computing device 431. Further, the server computing device 432 may allow use of the provided representations of the cards of the modifier deck 442 to change the play of the game based on what data the server computing device 432 transmits to the client computing device 431 and/or what input the server computing device 432 accepts from the client computing device 431.

Although the computer system 400 is illustrated and described above as including both a client computing device 431 and a server computing device 432 arranged in a client/server configuration that perform various operations for enabling play of and/or playing a card-based metagame, it is understood that this is an example. Other configurations are possible and contemplated without departing from the scope of the present disclosure.

For example, in various implementations, the storage medium 435 of the client computing device 431 may store the game deck 441, the modifier deck 442, and/or the one or more sets of rules such as the set of rules 443 for using the game deck 441 to play the game. The storage medium 435 may also store the one or more sets of instructions executable by the processing unit 434 to perform a method of enabling play of a card-based metagame. In such implementations, the server computing device 432 and/or the network 433 may or may not be included.

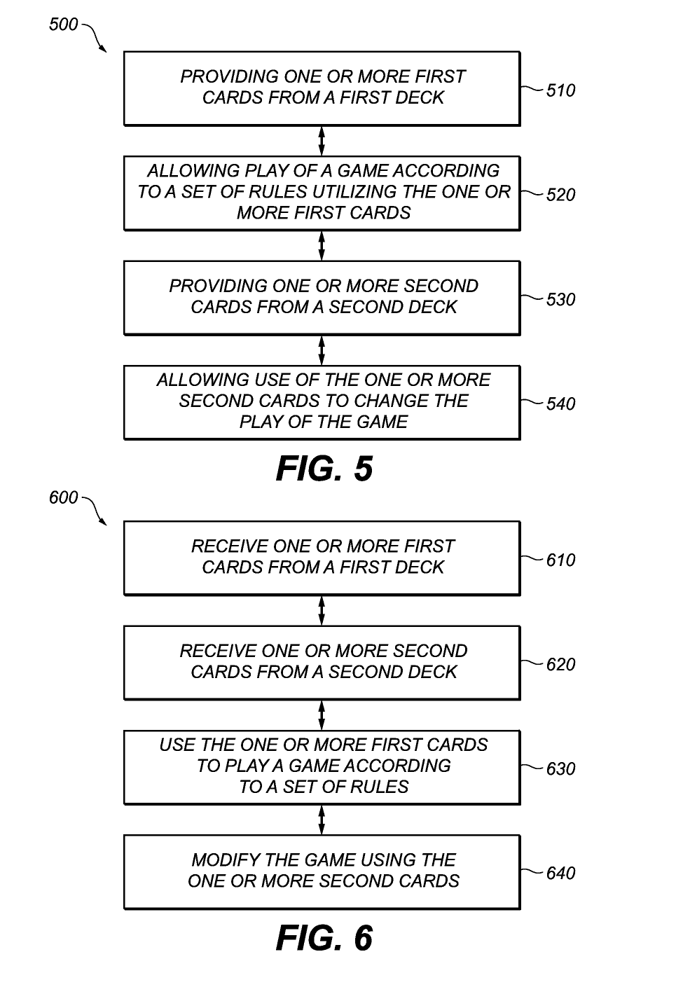

FIG. 5 depicts a flow chart illustrating a method 500 for enabling play of a card-based metagame. The card-based metagame may be the card-based metagame depicted in FIGS. 1 and/or 3A-3G. The method 500 may be performed by the computer system 400 of FIG. 4.

At 510, one or more first cards from a first deck may be provided. The first deck may be a game deck usable to play a card-based game. The first deck may be the standard playing card deck or the 52-card deck of French playing cards

At 520, play of the game according to a set of rules may be allowed utilizing the first cards. The game may be a poker game such as straight poker; draw poker; stud poker; pai gow poker; a community card poker game such as Texas hold 'em, Omaha hold 'em, Pineapple, Manilla, and so on; and so on. Alternatively, the game may be another kind of card-based game such as blackjack, baccarat, faro, gin rummy, progressive rummy, spades, crazy eights, hearts, whist, a trading card game, a customizable card game, and so on.

At 530, one or more second cards from a second deck may be provided. The second deck may be a modifier deck. The second deck may have cards specifically tailored to modifying the first deck, the set of rules, the game, and so on.

At 540, use of the second cards may be allowed to change the play of the game. The second cards may change one or more values (such as numerical value, suit, and so on) of the first cards, change the order of play, skip a player's turn, steal a turn for a player, switch various cards, cause a re-deal of one or more cards, and/or any other action that may influence and/or affect the game.

Although the example method 500 is illustrated and described as including particular operations performed in a particular order, it is understood that this is an example. In various implementations, various orders of the same, similar, and/or different operations may be performed without departing from the scope of the present disclosure.

For example, the example method 500 is illustrated and described as having discrete operations that are performed in a linear order. However, this is for purposes of clarity. In various examples, the first and second cards may be provided at the same and/or various times before, during, and/or after play of the game without departing from the scope of the present disclosure. Further, use of the second cards to change the play of the game may be allowed before, before, during, and/or after play of the game without departing from the scope of the present disclosure.

FIG. 6 depicts a flow chart illustrating a method 600 for playing a card-based metagame. The card-based metagame may be the card-based metagame depicted in FIGS. 1 and/or 3A-3G. The method 600 may be performed by the computer system 400 of FIG. 4.

At 610, one or more first cards from a first deck may be received. The first deck may be a game deck usable to play a card-based game. The first deck may be the standard playing card deck or the 52-card deck of French playing cards

At 620, one or more second cards from a second deck may be received. The second deck may have cards specifically tailored to modifying the first deck, the set of rules, the game, and so on.

At 630, the first cards may be used to play the game according to a set of rules. The game may be a poker game such as straight poker; draw poker; stud poker; pai gow poker; a community card poker game such as Texas hold 'em, Omaha hold 'em, Pineapple, Manilla, and so on; and so on. Alternatively, the game may be another kind of card-based game such as blackjack, baccarat, faro, gin rummy, progressive rummy, spades, crazy eights, hearts, whist, a trading card game, a customizable card game, and so on.

At 640, the game may be modified using the second cards. The second cards may change one or more values (such as numerical value, suit, and so on) of the first cards, change the order of play, skip a player's turn, steal a turn for a player, switch various cards, cause a re-deal of one or more cards, and/or any other action that may influence and/or affect the game.

Although the example method 600 is illustrated and described as including particular operations performed in a particular order, it is understood that this is an example. In various implementations, various orders of the same, similar, and/or different operations may be performed without departing from the scope of the present disclosure.

For example, the example method 600 is illustrated and described as having discrete operations that are performed in a linear order. However, this is for purposes of clarity. In various examples, the first and second cards may be received at the same and/or various times before, during, and/or after play of the game without departing from the scope of the present disclosure. Further, the game may be modified using the second cards before, before, during, and/or after play of the game without departing from the scope of the present disclosure.

As described above and illustrated in the accompanying figures, the present disclosure relates to methods and systems for card-based metagames. A card-based metagame may include a set of rules and a first deck of cards that are used to play a game according to the set of rules. The card-based metagame may also include a second deck of cards that may be used to change the play of the game. Through use of the second deck of cards, a greater variety of play may be provided for the game than would be possible without the second deck of cards. In some cases, use of the second deck of cards may also provide a greater opportunity for strategy based play than would be possible without the second deck of cards. Thus, card-based metagame may expand the play of the game.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A computer system, comprising:
a processing unit;
a communication component communicably coupled to the processing unit; and
a non-transitory storage medium, communicably coupled to the processing unit, storing:
first representations of a first deck of cards;
second representations of a second deck of cards;
a set of rules; and
instructions; wherein:
the processing unit executes the instructions stored in the non-transitory storage medium to:
provide at least one of the first representations of the first deck of cards;
provide at least one of the second representations of the second deck of cards;
allow play of a game according to the set of rules using the at least one of the first representations of the first deck of cards; and
allow use of the at least one of the second representations of the second deck of cards to change the play of the game.

2. The computer system of claim 1, wherein cards of the second deck of cards are not included in the first deck of cards.

3. The computer system of claim 1, wherein the second deck of cards comprises a number of second decks that corresponds to a number of players of the game.

4. The computer system of claim 1, wherein the game comprises Texas hold 'em.

5. The computer system of claim 4, wherein the at least one of the second representations of the second deck of cards comprises at least one of:
a hole modification card;
a board modification card;
a community turn modification card;
a community flop modification card; or
a community river modification card.

6. The computer system of claim 4, wherein the at least one of the second representations of the second deck of cards comprises at least one of:
a value increment card;
a value decrement card;
a suit change card;
a re-deal card; or
a card switch card.

7. The computer system of claim 4, wherein the at least one of the second representations of the second deck of cards comprises at least one of:
a card combination creation card;
a bet modification card;
an extra card obtaining card;
an order of play alteration card; or
a view other player hole card.

8. A card-based metagame, comprising:
a first deck of cards;
a second deck of cards; and
a set of rules; wherein:
the first deck of cards is used to play of a game according to the set of rules; and
the second deck of cards is used to change the play of the game.

9. The card-based metagame of claim 8, further comprising an additional set of rules, wherein:
the second deck of cards is used according to the additional set of rules to change the play of the game.

10. The card-based metagame of claim 9, wherein the additional set of rules specifies a time when cards of the second deck of cards may be used.

11. The card-based metagame of claim 8, wherein:
the first deck of cards comprises a first digital graphic representation; and
the second deck of cards comprises a second digital graphic representation.

12. The card-based metagame of claim 8, wherein the first deck of cards comprises a 52-card deck of French playing cards.

13. The card-based metagame of claim 8, wherein the game comprises a poker game.

14. The card-based metagame of claim 8, wherein at least one of the second deck of cards includes a use limitation.

15. A method of enabling play of a card-based metagame, comprising:
providing at least one of a first deck of cards;
allowing play of a game according to a set of rules using the at least one of the first deck of cards;
providing at least one of a second deck of cards; and
allowing use of the at least one of the second deck of cards to change the play of the game.

16. The method of claim 15, further comprising accepting at least one bet on the game.

17. The method of claim 15, further comprising providing at least one additional card of the first deck of cards in response to use of the at least one of the second deck of cards.

18. The method of claim 15, wherein the operation of providing the at least one of the first deck of cards comprises transmitting data regarding the at least one of the first deck of cards to a browser of a client computer.

19. The method of claim 15, wherein:
the first deck of cards and the second deck of cards have at least one card in common; and
the at least one card has a different function with respect to the first deck of cards than with respect to the second deck of cards.

20. The method of claim 15, wherein the operation of providing the at least one of the second deck of cards further comprises:
providing the at least one of the second deck of cards to a first player; and
concealing the at least one of the second deck of cards from a second player until the at least one of the second deck of cards is used.
